(19) United States
(12) Patent Application Publication
(10) Pub. No.: US 2024/0302827 A1
(43) Pub. Date: Sep. 12, 2024

(54) PRODUCTION PLANNING DEVICE, PRODUCTION PLANNING METHOD, AND NON-TRANSITORY COMPUTER READABLE MEDIUM

(71) Applicant: Mitsubishi Electric Corporation, Tokyo (JP)

(72) Inventor: Maki KITAMURA, Tokyo (JP)

(73) Assignee: Mitsubishi Electric Corporation, Tokyo (JP)

(21) Appl. No.: 18/665,107

(22) Filed: May 15, 2024

Related U.S. Application Data
(63) Continuation of application No. PCT/JP2022/003808, filed on Feb. 1, 2022.

(51) Int. Cl. G05B 19/418

(52) U.S. Cl. CPC G05B 19/41865; G05B 19/41885; G05B 2219/31449; G05B 2219/32365

(57) ABSTRACT

A production planning device (100) includes a simulation unit (106). A simulation unit (106) performs a discrete simulation based on a fixed plan model indicating a work related to a fixed plan product, which is a product, and a fixed plan period, which is a period in which the work related to the fixed plan product is performed, a semi-fixed plan model indicating a preparation period for performing the work related to the fixed plan product, and a fluid plan model indicating a work related to a fluid plan product, which is a product, so as to calculate a candidate period, which is a period not overlapping with the fixed plan period, as a candidate for a fluid plan period, which is a period in which the work indicated by the fluid plan model is performed, and when at least part of the candidate period overlaps with at least part of the preparation period and in a case where preparation for performing the work related to the fixed plan product is ready at a start time of the fixed plan period, determines the candidate period as the fluid plan period.

### CROSS REFERENCE TO RELATED APPLICATIONS

This application is a Continuation of PCT International Application No. PCT/JP2022/003808, filed on Feb. 1, 2022, all of which is hereby expressly incorporated by reference into the present application.

### TECHNICAL FIELD

The present disclosure relates to a production planning device, a production planning method, and a production planning program.

### BACKGROUND ART

In production planning in variable-mix variable-volume production, a setup change is required each time the product to be produced changes, and productivity may vary greatly depending on the order in which products are produced. Therefore, in variable-mix variable-volume production, there is a need for optimization of production planning using production planning software or the like.

Patent Literature 1 discloses a technology in which recommended assembly planned dates for fixed orders whose assembly planned dates have been set are allocated by leveling a production load, and then recommended assembly planned dates for variable orders whose assembly planned dates have not been set are allocated to vacant slots by leveling the production load.

### CITATION LIST

### Patent Literature

Patent Literature 1: JP 2019-148945 A

### SUMMARY OF INVENTION

### Technical Problem

In variable-mix variable-volume production, it may be necessary to perform a setup change in order to perform a work indicated by a fixed plan, which is a plan to perform a work related to a product in a predetermined period. Therefore, along with the fixed plan, it is necessary to create a semi-fixed plan, which is a plan indicating a period required for the setup change. However, it is sufficient that preparation for performing the work indicated by the fixed plan is ready at the start of the period indicated by the fixed plan, so that the semi-fixed plan may be adjusted as appropriate, provided that the preparation for performing the work related to the product indicated by the fixed plan is ready at the start of the period indicated by the fixed plan. That is, a fluid plan may be created by reducing at least part of the period indicated by the semi-fixed plan. By creating a fluid plan by reducing at least part of the period indicated by the semi-fixed plan, it may be possible to perform works related to products more efficiently. A fluid plan is a plan to perform a work related to a product in a period that is not predetermined.

However, according to the technology disclosed in Patent Literature 1, a problem is that a fluid plan is not created by reducing at least part of the period indicated by a semi-fixed plan.

An object of the present disclosure is to create a fluid plan by reducing at least part of a period indicated by a semi-fixed plan, provided that preparation for performing a work related to a fixed plan is ready at the start of a period indicated by the fixed plan.

### Solution to Problem

A production planning device according to the present disclosure includes
a simulation unit to perform a discrete simulation based on a fixed plan model, a semi-fixed plan model, and a fluid plan model, the fixed plan model being a model indicating a work related to a fixed plan product, which is a product, and a fixed plan period, which is a period in which the work related to the fixed plan product is performed, the semi-fixed plan model being a model indicating a preparation period for performing the work related to the fixed plan product, the fluid plan model being a model indicating a work related to a fluid plan product, which is a product, so as calculate a candidate period as a candidate for a fluid plan period, the candidate period being a period not overlapping with the fixed plan period, the fluid plan period being a period in which the work indicated by the fluid plan model is performed, and
when at least part of the candidate period overlaps with at least part of the preparation period and in a case where preparation for performing the work related to the fixed plan product is ready at a start time of the fixed plan period, determine the candidate period as the fluid plan period.

### Advantageous Effects of Invention

In the present disclosure, a fixed plan is a plan corresponding to a fixed plan model, a semi-fixed plan is a plan corresponding to a semi-fixed plan model, and a fluid plan is a plan corresponding to a fluid plan model. A simulation unit calculates a candidate period, which is a period not overlapping with a fixed plan period, as a candidate for a period in which a work indicated by the fluid plan model is performed. When at least part of the candidate period overlaps with at least part of a preparation period and in a case where preparation for performing a work related to a product indicated by the fixed plan model is ready at a start time of a period indicated by the fixed plan model, the simulation unit determines the candidate period as a period in which a work related to the fluid plan model is performed. Therefore, according to the present disclosure, a fluid plan can be created by reducing at least part of a period indicated by a semi-fixed plan, provided that preparation for performing a work related to a product indicated by a fixed plan is ready at the start of a period indicated by the fixed plan.

### BRIEF DESCRIPTION OF DRAWINGS

FIG. 1 is a figure illustrating an example of a configuration of a production planning device 100 according to Embodiment 1;

FIG. 2 is a figure illustrating a specific example of information according to Embodiment 1, where (a) is a table indicating fluid order information 201 and (b) is a table indicating fixed order information 202;

FIG. 3 is a figure illustrating a specific example of information according to Embodiment 1, where (a) is a table indicating resource information 203 and (b) is a table indicating a production plan 204;

FIG. 4 is a figure illustrating an example of a hardware configuration of the production planning device 100 according to Embodiment 1;

FIG. 5 is a flowchart illustrating operation of the production planning device 100 according to Embodiment 1;

FIG. 6 is a flowchart illustrating operation of a simulation unit 106 according to Embodiment 1;

FIG. 7 is a figure describing a work plan allocation process according to Embodiment 1;

FIG. 8 is a figure describing the work plan allocation process according to Embodiment 1;

FIG. 9 is a figure illustrating an example of a hardware configuration of the production planning device 100 according to a variation of Embodiment 1;

FIG. 10 is a figure describing the work plan allocation process according to Embodiment 2;

FIG. 11 is a flowchart illustrating operation of the simulation unit 106 according to Embodiment 3; and

FIG. 12 is a figure describing the work plan allocation process according to Embodiment 3.

### DESCRIPTION OF EMBODIMENTS

In the description and drawings of embodiments, the same elements and corresponding elements are denoted by the same reference sign. The description of elements denoted by the same reference sign will be suitably omitted or simplified. Arrows in figures mainly indicate flows of data or flows of processing. “Unit” may be suitably interpreted as “circuit”, “step”, “procedure”, “process”, or “circuitry”.

### Embodiment 1

This embodiment will be described in detail below with reference to the drawings.

### *** Description of Configuration ***

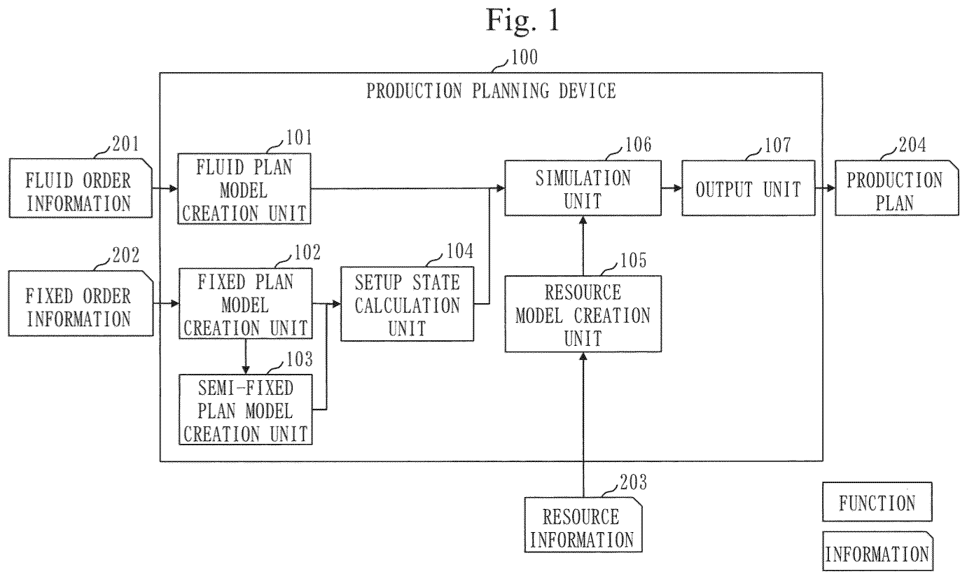

FIG. 1 illustrates an example of a system configuration of a production planning device 100 according to this embodiment. As illustrated in FIG. 1, the production planning device 100 is composed of a fluid plan model creation unit 101, a fixed plan model creation unit 102, a semi-fixed plan model creation unit 103, a setup state calculation unit 104, a resource model creation unit 105, a simulation unit 106, and an output unit 107. The production planning device 100 is also called a production plan simulation device with a plan fixing function.

Each of fluid order information 201, fixed order information 202, and resource information 203 is input into the production planning device 100. A production plan 204 is output from the production planning device 100.

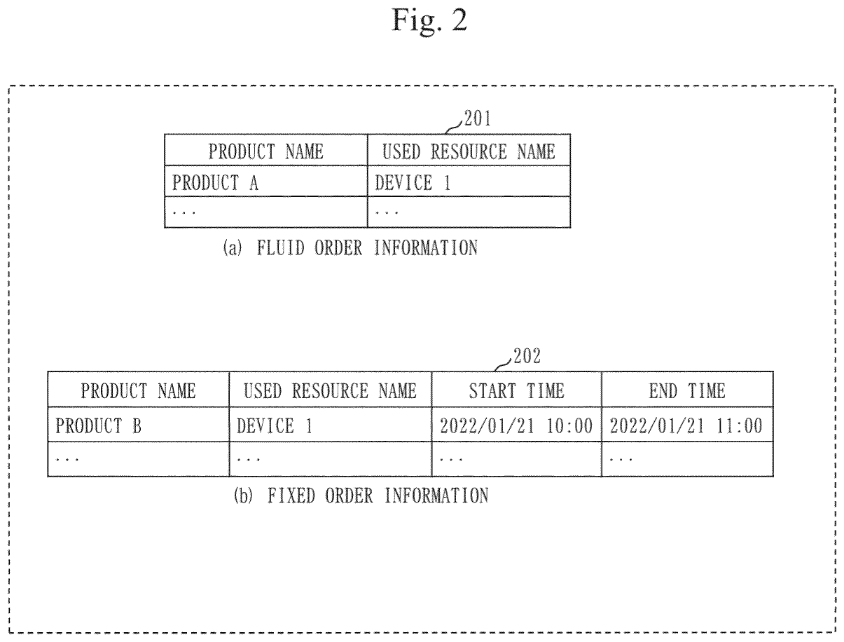

The fluid order information 201 is information indicating a product whose period for being worked on has not been set among products to be worked on. In FIG. 2, (a) indicates a specific example of the fluid order information 201. In this example, a “product name” and a “used resource name” are set. The “used resource name” indicates the name of a resource to be used in a work related to a product.

The fixed order information 202 is information indicating a product whose period for being worked on has been set among the products to be worked on. As a specific example, the fixed order information 202 indicates a start time of a work, an end time of the work, and a resource to be used in the work. In FIG. 2, (b) indicates a specific example of the fixed order information 202. In this example, in addition to a “product name” and a “used resource name”, a work period is set by setting a “start time” and an “end time”.

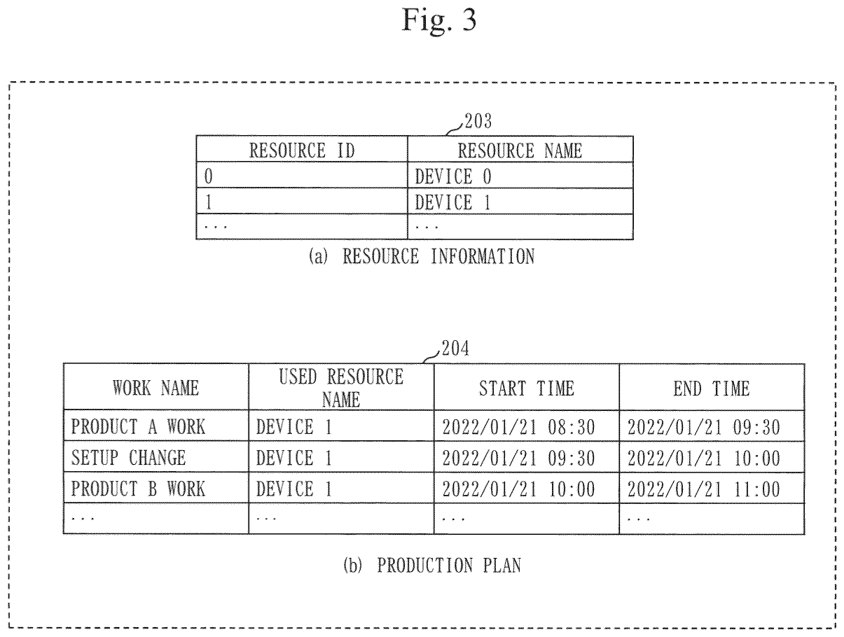

The resource information 203 is information indicating resources to be used for performing works related to products. The resource information 203 may be information according to a work plan and indicating availability of resources. In FIG. 3, (a) indicates a specific example of the resource information 203. In this example, a “resource ID (identification)” and a “resource name” are set.

The production plan 204 is information indicating a production plan and indicating a period in which a work related to each product to be worked on in variable-mix variable-volume production, a resource to be used in the work related to each product, and so on. In FIG. 3, (b) indicates a specific example of the production plan 204. In this example, a “used resource name”, a “start time”, and an “end time” are set for each “work name”.

The fluid plan model creation unit 101 receives the fluid order information 201, and creates a fluid plan model, which is a work model, based on information indicated in the fluid order information 201 that has been received. The work model is a model indicating a work related to a product. As a specific example, the work model indicates a resource to be used in a work for producing a product, a work time period, an order of steps, and so on. The resource is, as a specific example, at least one of a device, a jig, and a worker. The fluid plan model is a model indicating a work related to a fluid plan product, which is a product. In this embodiment, the work related to the fluid plan product is production of the fluid plan product. The fluid plan model creation unit 101 may create a plurality of fluid plan models.

In a fluid plan, which is a work plan indicated by the fluid plan model, the work period and the resource to be used in the work are not specifically set. That is, as a specific example, the type of device, the type of jig, the number of workers, and the length of the work period are set in the fluid plan, but the device to be used, the jig to be used, and the workers who perform the work are not specifically set. The fluid plan is a work plan that is to be allocated to a resource model and has not been allocated to the resource model. The work period is a period from a work start time to a work end time. The resource model includes information indicating each resource to be used in a work and information indicating a period in which each resource is used. Allocating a work plan to the resource model is, as a specific example, setting in the resource model that the resource to be used when the work plan is executed is occupied by the work plan in the period indicated by the work plan.

The fixed plan model creation unit 102 receives the fixed order information 202, and creates a fixed plan model, which is a work model, based on information indicated in the fixed order information 202 that has been received. The fixed plan model is a model indicating a work related to a fixed plan product, which is a product, and a fixed plan period, which is a period in which the work related to the fixed plan product is performed. In this embodiment, the work related to the fixed plan product is production of the fixed plan product. The fixed plan model creation unit 102 may create a plurality of fixed plan models.

In a fixed plan, which is a work plan indicated by the fixed plan model, a work period and a resource to be used in the work are specifically set. The fixed plan is a work plan which is allocated to the resource model and in which the work period and the resource to be used in the work have already been set.

The semi-fixed plan model creation unit 103 creates a semi-fixed plan model corresponding to the fixed plan model based on the fixed plan model. Specifically, the semi-fixed plan model creation unit 103 refers to the fixed plan model created by the fixed plan model creation unit 102, secures a period of time required for a setup change necessary for performing the work indicated by the fixed plan model immediately before the start time of the work period indicated by the fixed plan model, sets a plan indicating the secured period as a semi-fixed plan, and sets a model indicating the semi-fixed plan as the semi-fixed plan model. The semi-fixed plan model is a model indicating a preparation period for performing the work related to the fixed plan product. The length of the preparation period indicated by the semi-fixed plan model may be the length of the time required for a setup change for performing the work related to the fixed plan product. The preparation period is, as a specific example, the period required for the setup change. The semi-fixed plan model may be a work model indicating a work to be performed in the setup change. The semi-fixed plan model creation unit 103 may create a plurality of semi-fixed plan models.

The setup state calculation unit 104 refers to the fixed plan model created by the fixed plan model creation unit 102, and calculates a resource state in the period secured by the semi-fixed plan model creation unit 103. Specifically, the setup state calculation unit 104 calculates a setup state. The setup state is, as a specific example, a state such that at the end time of the period indicated by the semi-fixed plan, preparation for executing the fixed plan to be executed immediately after the end time is ready. When a semi-fixed plan is created along with a fixed plan for a certain device and when the certain device is in the setup state, the state of the certain device at the end time of the period indicated by the created semi-fixed plan is a state in which the fixed plan can be executed. The state of the certain device is, as a specific example, the number of times the certain device is used consecutively or the state of oil contained in the certain device. The state in which the fixed plan can be executed is, as a specific example, that the number of consecutive uses of the certain device is equal to or less than the upper limit, that the type of oil contained in the certain device is the same as the type of oil used when the fixed plan is carried out, or the like. In Embodiment 1, the setup state of a resource represents a state in which a condition regarding the number of consecutive uses of the device is satisfied.

The resource model creation unit 105 creates, based on the resource information 203, a resource model that is used in a simulation performed by the simulation unit 106 and indicates resources.

The simulation unit 106 receives the fixed plan model, the semi-fixed plan model, the fluid plan model, and the resource model, and performs a discrete simulation using the received models so as to allocate the work plan corresponding to the fluid plan model to the production plan 204 depending on a resource availability situation. The simulation unit 106 performs the discrete simulation based on the fixed plan model, the semi-fixed plan model, and the fluid plan model so as to calculate a candidate period, which is a period not overlapping with the fixed plan period, as a candidate for a fluid plan period. The fluid plan period is a period in which the work indicated by the fluid plan model is performed. When at least part of the candidate period overlaps with at least part of the preparation period and if preparation for performing the work related to the fixed plan product is ready at the start time of the fixed plan period, the simulation unit 106 determines the candidate period as the fluid plan period. The simulation unit 106 may calculate the candidate period so as to result in a short total length of the length of a preparation period for performing the work related to the fixed plan product and the length of a preparation period for performing the work related to the fluid plan product. The simulation unit 106 may calculate the candidate period based on the state of each resource to be used in the work related to a product.

The output unit 107 outputs the production plan 204 created by the simulation unit 106.

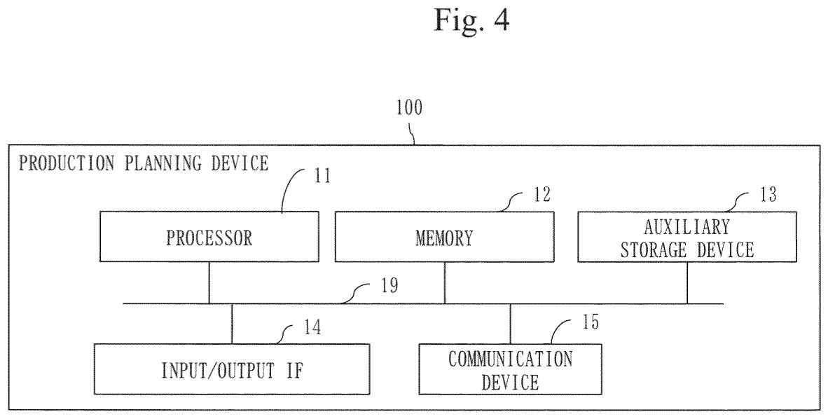

FIG. 4 illustrates an example of a hardware configuration of the production planning device 100 according to this embodiment. The production planning device 100 is composed of a computer. The production planning device 100 may be composed of a plurality of computers.

As illustrated in FIG. 4, the production planning device 100 is a computer that includes hardware components such as a processor 11, a memory 12, an auxiliary storage device 13, an input/output interface (IF) 14, and a communication device 15. These hardware components are connected as appropriate through a signal line 19.

The processor 11 is an integrated circuit (IC) that performs operational processing, and controls the hardware included in the computer. The processor 11 is, as a specific example, a central processing unit (CPU), a digital signal processor (DSP), or a graphics processing unit (GPU).

The production planning device 100 may include a plurality of processors as an alternative to the processor 11. The plurality of processors share the role of the processor 11.

The memory 12 is, typically, a volatile storage device and is, as a specific example, a random access memory (RAM). The memory 12 is also called a main storage device or a main memory. Data stored in the memory 12 is saved in the auxiliary storage device 13 as necessary.

The auxiliary storage device 13 is, typically, a non-volatile storage device and is, as a specific example, a read only memory (ROM), a hard disk drive (HDD), or a flash memory. Data stored in the auxiliary storage device 13 is loaded into the memory 12 as necessary.

The memory 12 and the auxiliary storage device 13 may be configured integrally.

The input/output IF 14 is a port to which an input device and an output device are connected. The input/output IF 14 is, as a specific example, a Universal Serial Bus (USB) terminal. The input device is, as a specific example, a keyboard and a mouse. The output device is, as a specific example, a display.

The communication device 15 is a receiver and a transmitter. The communication device 15 is, as a specific example, a communication chip or a network interface card (NIC).

Each unit of the production planning device 100 may use the input/output IF 14 and the communication device 15 as appropriate when communicating with other devices and so on.

The auxiliary storage device 13 stores a production planning program. The production planning program is a program that causes a computer to realize the functions of each unit included in the production planning device 100. The production planning program is loaded into the memory 12 and executed by the processor 11. The functions of each unit included in the production planning device 100 are realized by software.

Data used when the production planning program is executed, data obtained by executing the production planning program, and so on are stored in a storage device as appropriate. Each unit of the production planning device 100 uses the storage device as appropriate. As a specific example, the storage device is composed of at least one of the memory 12, the auxiliary storage device 13, a register in the processor 11, and a cache memory in the processor 11. Data and information may have substantially the same meaning. The storage device may be independent of the computer.

The functions of the memory 12 and the auxiliary storage device 13 may be realized by other storage devices.

The production planning program may be recorded in a computer readable non-volatile recording medium. The non-volatile recording medium is, as a specific example, an optical disc or a flash memory. The production planning program may be provided as a program product.

### *** Description of Operation ***

A procedure for operation of the production planning device 100 is equivalent to a production planning method. A program that realizes the operation of the production planning device 100 is equivalent to the production planning program.

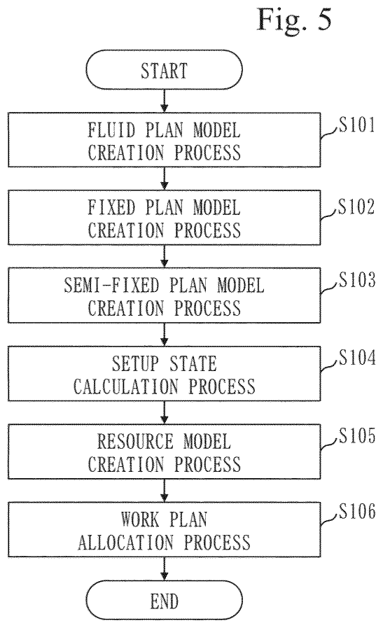

FIG. 5 is a flowchart illustrating an example of the operation of the production planning device 100. Referring to FIG. 5, the operation of the production planning device 100 will be described.

### (Step S101)

The fluid plan model creation unit 101 takes as input the fluid order information 201, and creates a fluid plan model corresponding to the fluid order information 201.

### (Step S102)

The fixed plan model creation unit 102 takes as input the fixed order information 202, and creates a fixed plan model corresponding to the fixed order information 202.

### (Step S103)

The semi-fixed plan model creation unit 103 secures a period of time required for a setup change necessary for performing the work indicated by the fixed plan model immediately before the start time of the work period indicated by the fixed plan model created by the fixed plan model creation unit 102, and creates a semi-fixed plan model indicating the secured period.

### (Step S104)

The setup state calculation unit 104 calculates a setup state corresponding to the semi-fixed plan model created by the semi-fixed plan model creation unit 103 by referring to the fixed plan model created by the fixed plan model creation unit 102, and assigns the calculated setup state to the semi-fixed plan model.

### (Step S105)

The resource model creation unit 105 takes as input the resource information 203, and creates a resource model corresponding to the resource information 203.

### (Step S106)

The simulation unit 106 receives the fluid plan model, the fixed plan model, the semi-fixed plan model, and the resource model, and allocates a fixed plan corresponding to each received fixed plan model and a semi-fixed plan corresponding to each received semi-fixed plan model to the received resource model. Then, the simulation unit 106 allocates a fluid plan corresponding to each received fluid plan model while performing a discrete simulation.

Then, the simulation unit 106 creates the production plan 204 corresponding to the resource model to which each work plan has been allocated, and outputs the production plan 204 that has been created.

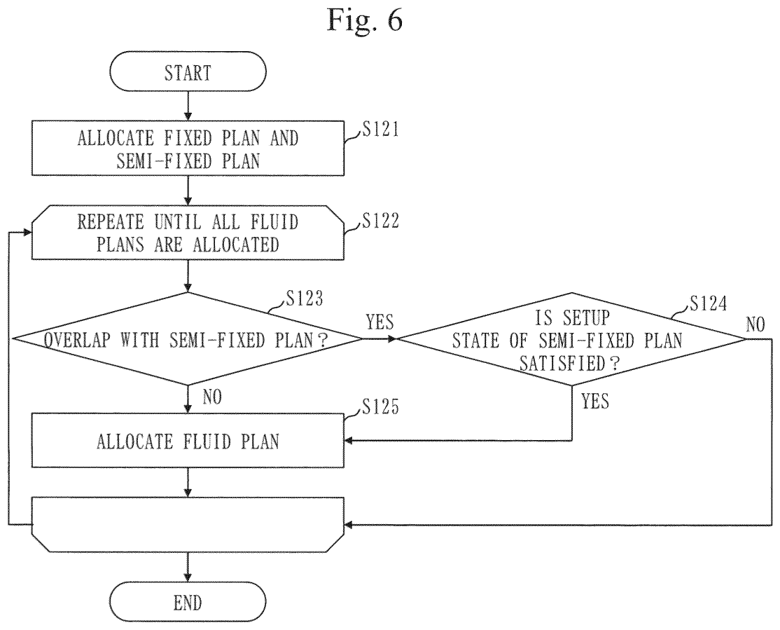

FIG. 6 is a flowchart illustrating an example of a work plan allocation process. Using FIG. 6, the work plan allocation process will be described. The work plan allocation process is a process of allocating work plans to the resource model or the production plan 204.

### (Step S121)

The simulation unit 106 allocates each fixed plan and each semi-fixed plan to the resource model according to the work period and resource indicated by the fixed plan corresponding to each fixed plan model and the period and resource indicated by the semi-fixed plan corresponding to each semi-fixed plan model.

### (Step S122)

In the resource model, the simulation unit 106 allocates, in chronological order, each fluid plan to an available resource, that is, a resource that can be used in a period not overlapping with the work period indicated by the fixed plan while checking the availability situation of each resource. The period indicated by the fluid plan allocated in this this step is a candidate period.

### (Step S123)

If there is an overlap between the work period indicated by the fluid plan allocated in step S122 and the period indicated by the semi-fixed plan, the simulation unit 106 proceeds to step S124. In other cases, the simulation unit 106 proceeds to step S125.

### (Step S124)

If the setup state indicated by the semi-fixed plan is satisfied at the end time of the period indicated by the semi-fixed plan, the simulation unit 106 proceeds to step S125. In other cases, the simulation unit 106 proceeds to step S122.

### (Step S125)

The simulation unit 106 allocates the fluid plan corresponding to each fluid plan model to the resource model. In this step, the simulation unit 106 determines the candidate period as the fluid plan period.

When there is an overlap between the work period indicated by the fluid plan and the period indicated by the semi-fixed plan, the simulation unit 106 can reduce the semi-fixed plan and allocate the fluid plan to the resource model if the resource is in the setup state at the end time of the period indicated by the semi-fixed plan.

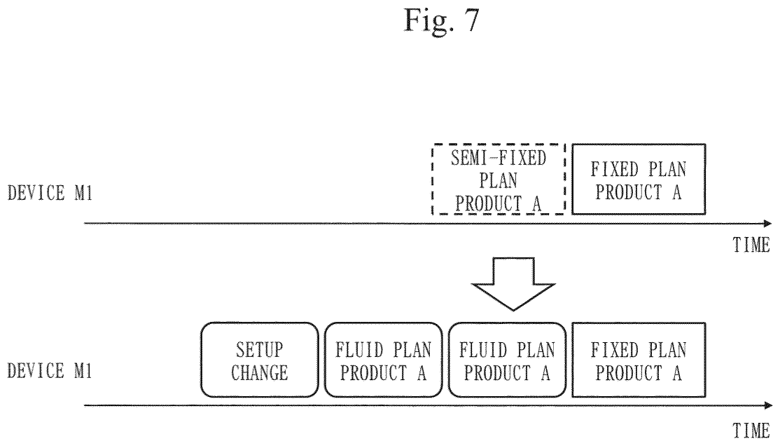

Using FIG. 7, a specific example of the work plan allocation process in a case where a product A is produced using a device M1 will be described. The device M1 is a device whose upper limit on the number of consecutive uses is three times, and which requires a setup change after three consecutive uses. It is assumed that the product to be produced in each work plan is the product A, and the resource for producing the product A is only one device M1. It is also assumed that the number of products A to be produced is three, and one of them is produced by executing a fixed plan and thus the production period is fixed, and the other two are produced by executing fluid plans.

First, as indicated in the upper part of FIG. 7, the simulation unit 106 allocates a fixed plan corresponding to a fixed plan model to the work period indicated by the fixed plan in the resource model. The simulation unit 106 also allocates a semi-fixed plan corresponding to a semi-fixed plan model corresponding to the fixed plan model to the period indicated by the semi-fixed plan in the resource model. In FIG. 7, “FIXED PLAN PRODUCT A” indicates that the device M1 is occupied during the period indicated by the frame surrounding “FIXED PLAN PRODUCT A” in order to produce the product A by executing the fixed plan. The semi-fixed plan includes information indicating a setup state for producing the product A indicated by the fixed plan. In addition, at the end time of the period indicated by the semi-fixed plan, it is necessary to be in the setup state, that is, in a state in which the product A can be produced. In this example, the upper limit on the number of consecutive uses of the device M1 is three times. Therefore, the semi-fixed plan includes information indicating that the number of consecutive uses of the device M1 needs to be two or less at the end time of the period indicated by the semi-fixed plan.

Next, as indicated in the lower part of FIG. 7, the simulation unit 106 allocates a fluid plan corresponding to each fluid plan model to the resource model in chronological order while performing a discrete simulation.

First, the simulation unit 106 allocates a setup change to the resource model to set up a state in which the product A can be produced.

Then, the simulation unit 106 allocates a first fluid plan to the resource model.

Then, the simulation unit 106 determines whether a second fluid plan can be allocated to a period that overlaps with the semi-fixed plan. If the second fluid plan is allocated to the period indicated by the semi-fixed plan, the number of consecutive uses of the device M1 is twice at the end time of the work period indicated by the second fluid plan, so that the setup state indicated by the semi-fixed plan is satisfied. Therefore, the simulation unit 106 determines that the second fluid plan can be allocated to the period that overlaps with the semi-fixed plan, reduces the semi-fixed plan, and allocates the second fluid plan to this period.

Then, the simulation unit 106 allocates the fixed plan to the work period indicated by the fixed plan in the resource model, and ends the simulation. The fixed plan is a plan to produce the product A for the third time consecutively.

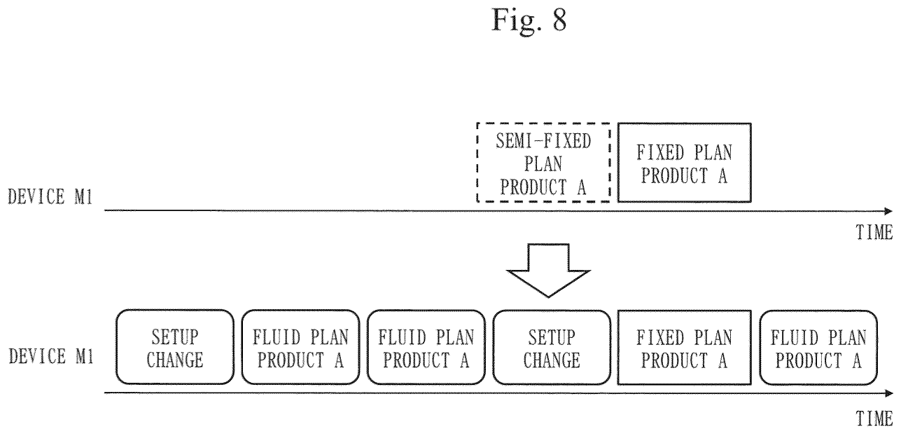

Using FIG. 8, a specific example of the work plan allocation process will be described. It is assumed that the specific example is substantially the same as the specific example indicated in FIG. 7, except that the number of products A to be produced is four and three of them are produced by executing fluid plans.

First, as indicated in the upper part of FIG. 8, the simulation unit 106 allocates a fixed plan and a semi-fixed plan to the resource model, as in the upper part of FIG. 7.

Next, the simulation unit 106 allocates a fluid plan corresponding to each fluid plan model to the resource model in chronological order while performing a discrete simulation.

First, the simulation unit 106 allocates a setup change to the resource model so as to set up a state in which the product A can be produced.

Then, the simulation unit 106 allocates first and second fluid plans to the resource model.

Then, if a third fluid plan is allocated immediately after the second fluid plan, there is an overlap between the work period indicated by the third fluid plan and the period indicated by the semi-fixed plan, so that the simulation unit 106 determines whether the third fluid plan can be allocated immediately after the second fluid plan. If the third fluid plan is allocated to the period indicated by the semi-fixed plan, the number of consecutive uses of the device M1 at the end time of the work period indicated by the third fluid plan is three times. Therefore, if the third fluid plan is allocated immediately after the second fluid plan, the setup state indicated by the semi-fixed plan is not satisfied, so that the simulation unit 106 determines that the third fluid plan cannot be allocated immediately after the second fluid plan. Therefore, the simulation unit 106 sets that a setup change is to be performed in the period indicated by the semi-fixed plan.

Then, the simulation unit 106 allocates the third fluid plan immediately after the end time of the work period indicated by the fixed plan.

Therefore, in this example, by performing the setup change earlier to fit the fixed plan, a fluid plan can be allocated immediately after the end time of the work period indicated by the fixed plan.

### Description of Effects of Embodiment 1

As described above, according to this embodiment, by setting a semi-fixed plan corresponding to a fixed plan, work plans can be allocated to a resource model while taking into account the state of each resource that changes in chronological order. In addition, according to this embodiment, a production plan can be created by inserting a plan to perform a setup change while taking into account the state of each resource that changes as work plans are executed consecutively.

### *** Other Configurations ***

### <Variation 1>

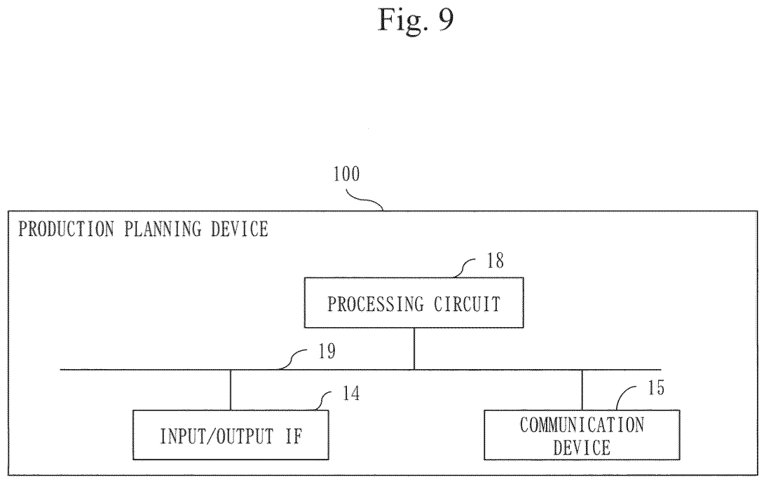

FIG. 9 illustrates an example of a hardware configuration of the production planning device 100 according to this variation.

The production planning device 100 includes a processing circuit 18 in place of the processor 11, in place of the processor 11 and the memory 12, in place of the processor 11 and the auxiliary storage device 13, or in place of the processor 11, the memory 12, and the auxiliary storage device 13.

The processing circuit 18 is dedicated hardware that realizes at least part of the units included in the production planning device 100.

The processing circuit 18 may be dedicated hardware, or may be a processor that executes programs stored in the memory 12.

When the processing circuit 18 is dedicated hardware, the processing circuit 18 is, as a specific example, a single circuit, a composite circuit, a programmed processor, a parallel-programmed processor, an application specific integrated circuit (ASIC), a field programmable gate array (FPGA), or a combination of these.

The production planning device 100 may include a plurality of processing circuits as an alternative to the processing circuit 18. The plurality of processing circuits share the role of the processing circuit 18.

In the production planning device 100, some functions may be realized by dedicated hardware, and the remaining functions may be realized by software or firmware.

As a specific example, the processing circuit 18 is realized by hardware, software, firmware, or a combination of these.

The processor 11, the memory 12, the auxiliary storage device 13, and the processing circuit 18 are collectively called “processing circuitry”. That is, the functions of the functional constituent elements of the production planning device 100 are realized by the processing circuitry.

The production planning device 100 according to other embodiments may also be configured in the same manner as this variation.

### Embodiment 2

Differences from the embodiment described above will be mainly described below with reference to the drawings.

### *** Description of Configuration ***

The configuration according to this embodiment is substantially the same as the configuration according to Embodiment 1. In Embodiment 2, work plans are allocated to a resource model in a case where there is a constraint on the continuous operating time period of a resource. In this embodiment, a work related to a fixed plan product is a test on the fixed plan product, and a work related to a fluid plan product is a test on the fluid plan product.

### *** Description of Operation ***

The flowchart indicating the operation of the production planning device 100 according to this embodiment is substantially the same as the flowchart indicating the operation of the production planning device 100 according to Embodiment 1.

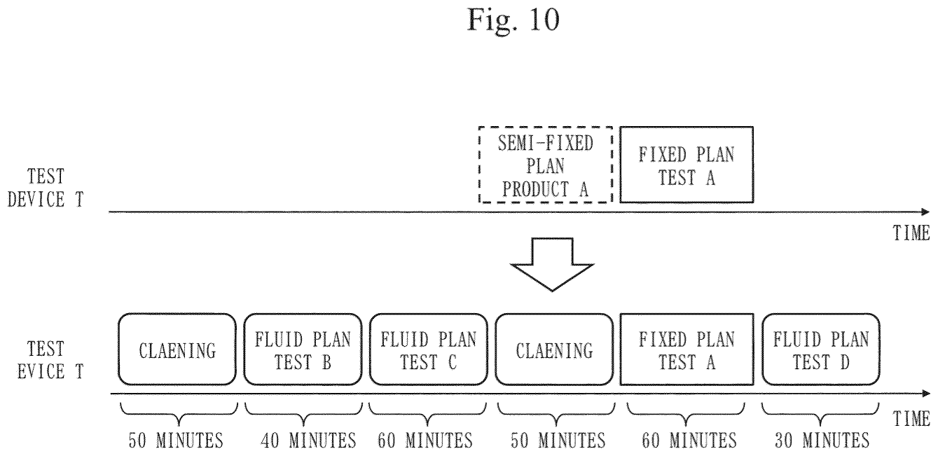

Using FIG. 10, a specific example of the work plan allocation process according to this embodiment will be described. In this example, it is assumed that a test device T is used to perform tests on a certain product. It is assumed that the test device T needs to be cleaned after being used continuously for a certain period of time, specifically, it is assumed that the test device T needs to be cleaned when the total operating time exceeds 150 minutes. It is assumed that the test device T is used to perform a test A, a test B, a test C, and a test D. It is assumed that the time required for each test is 60 minutes for the test A, 40 minutes for the test B, 60 minutes for the test C, and 30 minutes for the test D. It is assumed that the cleaning time of the test device T is 50 minutes. It is assumed that the test A is performed according to a fixed plan, so that the period in which the test A is performed has been determined. It is assumed that ordering of priority regarding allocation is specified for the test B, the test C, and the test D, and the tests need to be allocated to the resource model according to the ordering of priority such that the test B>the test C>the test D. In this example, the time required for a test is the length of a work period, and the period in which the test is performed is the work period.

First, as indicated in the upper part of FIG. 10, the simulation unit 106 allocates a fixed plan corresponding to a fixed plan model and a semi-fixed plan corresponding to a semi-fixed plan model corresponding to the fixed plan model to the resource model. The length of the period indicated by the semi-fixed plan is 50 minutes, which is the cleaning time of the test device T.

It is assumed that information is assigned to the semi-fixed plan by the setup state calculation unit 104. The information indicates, as the setup state of the semi-fixed plan, that the total operating time of the test device T at the end time of the period indicated by the semi-fixed plan needs to be not longer than 90 minutes, which is a time period obtained by subtracting 60 minutes, which is the time period required for the test A indicated by the fixed plan, from 150 minutes, which is the maximum total operating time period of the test device T.

Next, the simulation unit 106 performs a discrete simulation, and allocates a fluid plan corresponding to each fluid plan model to the resource model according to the priority level of the test indicated by each fluid plan model.

First, the simulation unit 106 sequentially allocates a plan to clean the test device T, a fluid plan indicating the test B, and a fluid plan indicating the test C to the resource model.

Then, if a fluid plan indicating the test D is allocated immediately after the end of the fluid plan indicating the test C, there is an overlap between the period for performing the test D and the period indicated by the semi-fixed plan, so that the simulation unit 106 determines whether the fluid plan indicating the test D can be allocated immediately after the end of the fluid plan indicating the test C. In this case, the continuous operating time period of the test device T at the start time of the test D is 100 minutes, and the continuous operating time period exceeds 90 minutes indicated by the setup state of the semi-fixed plan. Therefore, the simulation unit 106 determines that the fluid plan indicating the test D cannot be allocated immediately after the end of the fluid plan indicating the test C, and sets a plan to clean the test device T in the period indicated by the semi-fixed plan.

Then, the simulation unit 106 allocates the fluid plan indicating the test D immediately after the fixed plan indicating the test A.

### Description of Effects of Embodiment 2

As described above, according to this embodiment, fluid plans can be allocated to a resource model as in Embodiment 1 in a case where there is a constraint on the continuous operating time period of a resource.

### Embodiment 3

Differences from the embodiments described above will be mainly described below with reference to the drawings.

### *** Description of Configuration ***

The configuration according to this embodiment is substantially the same as the configuration according to the above embodiments. Embodiment 3 supports a case where the time period required for a setup change is shorter than the time period secured by a semi-fixed plan.

### *** Description of Operation ***

In the embodiments above, a period in which a setup change may be performed is set as a semi-fixed plan in a resource model, and depending on a result of performing a discrete simulation, it is determined whether to perform the setup change or to perform a work related to a product in place of the setup change in the period indicated by the semi-fixed plan.

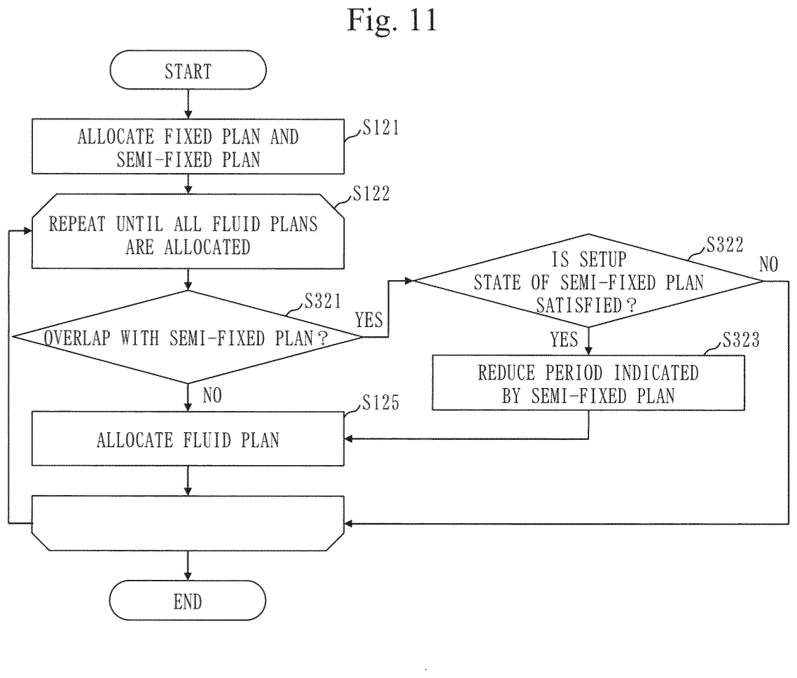

FIG. 11 is a flowchart illustrating an example of processing by the simulation unit 106 according to this embodiment. The flowchart differs from the flowchart according to Embodiments 1 and 2 in that after the setup state is determined, the time period required for a setup change is reduced and a work related to a product is allocated to a period corresponding to a time period by which the reduction has been made, instead of selecting one of two options which are whether to allocate a setup change or allocate a work related to a product to the period indicated by the semi-fixed plan.

### (Step S321)

If there is an overlap between the work period indicated by the fluid plan allocated in step S122 and part of the period indicated by the semi-fixed plan, the simulation unit 106 proceeds to step S322. In other cases, the simulation unit 106 proceeds to step S125.

### (Step S322)

If the setup state indicated by the semi-fixed plan is satisfied at the end time of the period indicated by the semi-fixed plan, the simulation unit 106 proceeds to step S323. In other cases, the simulation unit 106 proceeds to step S122.

### (Step S323)

In order to allocate the fluid plan, the simulation unit 106 cuts the part of the period indicated by the semi-fixed plan that overlaps with the work period indicated by the fluid plan. Then, the simulation unit 106 allocates a plan to perform a setup change to the period that remains as the period indicated by the semi-fixed plan.

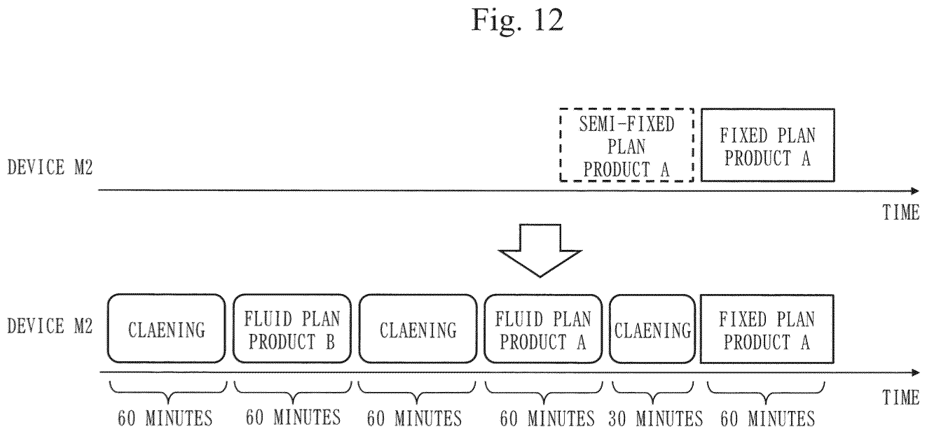

Using FIG. 12, a specific example of the work plan allocation process according to this embodiment will be described. In this example, it is assumed that there is a device M2 that produces a plurality of types of products, and the device M2 needs to be cleaned each time the device M2 is used. However, it is assumed that the degree of cleaning required for the device M2 varies depending on conditions, and a cleaning time period when products of the same type are produced consecutively is shorter than a cleaning time period when mutually different products are produced consecutively. Specifically, it is assumed that the cleaning time period of the device M2 is 30 minutes when products of the same type are produced consecutively, and 60 minutes in other cases. It is assumed that the device M2 is used to produce two products A and produce one product B. It is assumed that one of the two products A is produced by executing a fixed plan. It is assumed that the time period required to produce the product A and the time period required to produce the product B are both 60 minutes.

First, as indicated in the upper half of FIG. 12, the simulation unit 106 allocates, to the resource model, a fixed plan corresponding to a fixed plan model and a semi-fixed plan corresponding to a semi-fixed plan model corresponding to the fixed plan model and indicating the cleaning time period of 60 minutes for producing the product A indicated by the fixed plan.

Next, the simulation unit 106 allocates a fluid plan corresponding to each fluid plan model to the resource model in chronological order while performing a discrete simulation.

First, the simulation unit 106 sequentially allocates, to the resource model, a plan to clean the device M2 for 60 minutes and a fluid plan indicating production of the product B.

Then, the simulation unit 106 allocates, to the resource model, a plan to clean the device M2 for 60 minutes so as to set up a state in which the product A can be produced.

Then, if a fluid plan to produce the product A is allocated immediately after cleaning of the device M2, there is an overlap between the period indicated by the fluid plan and part of the period indicated by the semi-fixed plan, so that the simulation unit 106 determines whether the fluid plan can be allocated immediately after cleaning of the device M2. If it is assumed that the fluid plan is executed immediately after cleaning of the device M2, the product indicated by the fixed plan corresponding to the semi-fixed plan is the product A, and thus the cleaning time of the device M2 after the end of the fluid plan is only 30 minutes. Even if the product A is produced by executing the fluid plan immediately after cleaning of the device M2, the cleaning time of 30 minutes can be secured after the end of the fluid plan. Therefore, the simulation unit 106 determines that the fluid plan can be allocated immediately after cleaning of the device M2, and allocates the fluid plan immediately after cleaning of the device M2 in the resource model such that part of the period indicated by the fluid plan overlaps with part of the period indicated by the semi-fixed plan.

Then, the simulation unit 106 allocates, to the resource model, the plan to clean the device M2 for 30 minutes immediately after the end of the fluid plan. After the device M2 is cleaned for 30 minutes, the product A indicated by the fixed plan is produced.

### Description of Effects of Embodiment 3

As described above, according to this embodiment, it is possible to allocate a fluid plan to a resource model by reducing part of the period indicated by a semi-fixed plan.

### Other Embodiments

The above embodiments can be freely combined, or any constituent element of each of the embodiments can be modified. Alternatively, in each of the embodiments, any constituent element can be omitted.

The embodiments are not limited to those presented in Embodiments 1 to 3, and various modifications can be made as needed. The procedures described using the flowcharts or the like may be modified as appropriate.

### REFERENCE SIGNS LIST

11: processor, 12: memory, 13: auxiliary storage device, 14: input/output IF, 15: communication device, 18: processing circuit, 19: signal line, 100: production planning device, 101: fluid plan model creation unit, 102: fixed plan model creation unit, 103: semi-fixed plan model creation unit, 104: setup state calculation unit, 105: resource model creation unit, 106: simulation unit, 107: output unit, 201: fluid order information, 202: fixed order information, 203: resource information, 204: production plan.

1. A production planning device comprising
processing circuitry to perform a discrete simulation based on a fixed plan model, a semi-fixed plan model, and a fluid plan model, the fixed plan model being a model indicating a work related to a fixed plan product, which is a product, and a fixed plan period, which is a period in which the work related to the fixed plan product is performed, the semi-fixed plan model being a model indicating a preparation period for performing the work related to the fixed plan product, the fluid plan model being a model indicating a work related to a fluid plan product, which is a product, so as calculate a candidate period as a candidate for a fluid plan period, the candidate period being a period not overlapping with the fixed plan period, the fluid plan period being a period in which the work indicated by the fluid plan model is performed, and
when at least part of the candidate period overlaps with at least part of the preparation period and in a case where preparation for performing the work related to the fixed plan product is ready at a start time of the fixed plan period, determine the candidate period as the fluid plan period.

2. The production planning device according to claim 1,
wherein the processing circuitry creates the semi-fixed plan model based on the fixed plan model.

3. The production planning device according to claim 1,
wherein the processing circuitry calculates the candidate period so as to result in a short total length of a length of a preparation period for performing the work related to the fixed plan product and a length of a preparation period for performing the work related to the fluid plan product.

4. The production planning device according to claim 1,
wherein the processing circuitry calculates the candidate period based on a state of each resource to be used in a work related to a product.

5. The production planning device according to claim 1,
wherein the work related to the fixed plan product is one of production of the fixed plan product and a test on the fixed plan product, and
wherein the work related to the fluid plan product is one of production of the fluid plan product and a test on the fluid plan product.

6. The production planning device according to claim 1,
wherein a length of the preparation period indicated by the semi-fixed plan model is a length of a time period required for a setup change for performing the work related to the fixed plan product.

7. A production planning device method comprising:
performing a discrete simulation based on a fixed plan model, a semi-fixed plan model, and a fluid plan model, the fixed plan model being a model indicating a work related to a fixed plan product, which is a product, and a fixed plan period, which is a period in which the work related to the fixed plan product is performed, the semi-fixed plan model being a model indicating a preparation period for performing the work related to the fixed plan product, the fluid plan model being a model indicating a work related to a fluid plan product, which is a product, so as calculate a candidate period as a candidate for a fluid plan period, the candidate period being a period not overlapping with the fixed plan period, the fluid plan period being a period in which the work indicated by the fluid plan model is performed, and
when at least part of the candidate period overlaps with at least part of the preparation period and in a case where preparation for performing the work related to the fixed plan product is ready at a start time of the fixed plan period, determining the candidate period as the fluid plan period, by a computer.

8. A non-transitory computer readable medium storing a production planning program that causes a production planning device, which is a computer, to execute
a simulation process of performing a discrete simulation based on a fixed plan model, a semi-fixed plan model, and a fluid plan model, the fixed plan model being a model indicating a work related to a fixed plan product, which is a product, and a fixed plan period, which is a period in which the work related to the fixed plan product is performed, the semi-fixed plan model being a model indicating a preparation period for performing the work related to the fixed plan product, the fluid plan model being a model indicating a work related to a fluid plan product, which is a product, so as calculate a candidate period as a candidate for a fluid plan period, the candidate period being a period not overlapping with the fixed plan period, the fluid plan period being a period in which the work indicated by the fluid plan model is performed, and
when at least part of the candidate period overlaps with at least part of the preparation period and in a case where preparation for performing the work related to the fixed plan product is ready at a start time of the fixed plan period, determining the candidate period as the fluid plan period.
